(19) United States
(12) Patent Application Publication
(10) Pub. No.: US 2016/0045853 A1
(43) Pub. Date: Feb. 18, 2016

(54) DUST FILTRATION SYSTEM OF GAS MIXTURE OF HIGH TEMPERATURE OIL GAS, WATER VAPOR AND PRECIPITATION-PRONE CARBIDES

(71) Applicant: HENAN DRAGON INTO COAL TECHNOLOGY CO., LTD., Xixia Nanyang (CN)

(72) Inventor: Shucheng ZHU, Xixia Nanyang (CN)

(21) Appl. No.: 14/825,378

(22) Filed: Aug. 13, 2015

(30) Foreign Application Priority Data
Aug. 14, 2014 (CN) 201410398944.9

(51) Int. Cl. B01D 46/00

(52) U.S. Cl. CPC B01D 46/0065; B01D 46/0002; B01D 46/0019; B01D 46/0084

(57) ABSTRACT

The present invention discloses a dust filtration system of gas mixture of high temperature oil gas, water vapor and precipitation-prone carbides, which comprises a closed separation chamber connecting intake duct and exhaust duct. The closed separation chamber comprises a filter mechanism inside, the outer surface of the filter mechanism connects to the intake duct and the inner surface connects to the exhaust duct, and the dust filtration system comprises a filter regeneration mechanism. The present invention includes a filter regeneration mechanism set in the closed separation chamber connecting intake duct and exhaust duct, which can recover the filtering capacity greatly decreased due to the adhesion of tar and ash to the filter surface and pores. The repeated regeneration directly reduces the cost of filter and greatly improves its service life.

### FIELD OF THE INVENTION

The present invention relates to gas dust removal in coal chemical industry. More specifically, it relates to a dust filtration system of gas mixture of high temperature oil gas, water vapor and precipitation-prone carbides.

### BACKGROUND OF THE INVENTION

High-temperature dusty gas is often generated in chemical, petroleum, metallurgy and other industries, particularly in the pyrolysis of low rank coal with tar gas generated and other gas decomposed in order to improve coal quality. Coal turns and rolls, resulting in high dust content in the gas mixture, and the gaseous precipitation-prone carbides in the mixed gas such as tar coke and bituminous substances can only exist in the high temperature environment and tend to precipitate slowly from the mixed gas due to low temperature or environmental change. Precipitation-prone carbides such as tar coke and bituminous substances accumulate in the filter pores and cake. The appropriate filter cake can lead to better gas filtering effect, but once precipitation-prone carbides accumulate too much, they can clog the filter pores, while the filter cake will gradually thicken and lose its filtering capacity so that production can not continue. Even with continuous high temperature in the filter chamber, in the filtration process of the gas mixture with high dust content, due to the relationship between molecular liquefaction, solidification, exposure to environment and temperature change, precipitation-prone carbides such as tar coke and bituminous substances can still gradually precipitate at the position in frequent physical contact with the filter from the mixed gas, accumulate in the filter pores and make the filter cake thicken gradually and lost its filtering capacity. The replacement of filter inevitably leads to shutdown, and for large chemical devices in continuous operation, the shutdown and troubleshooting inevitably cause huge economic losses. For a long time, both at home and abroad, the problem of dust filtration of gas mixture of high temperature oil gas, water vapor and precipitation-prone carbide, in particular the dedusting problem of mixed oil gas with high dust content has not been effectively addressed, and the industrialized production can not be achieved, which directly affects the world's current overall pattern of coal industry so that the huge amount of low rank coal can not be quickly and efficiently utilized.

### SUMMARY OF THE INVENTION

The present invention to solve the above problems in the process proposed a dust filtration system of gas mixture of high temperature oil gas, water vapor and precipitation-prone carbides that has a simple structure and outstanding effect.

A dust filtration system of gas mixture of high temperature oil gas, water vapor and precipitation-prone carbides that has a simple structure and outstanding effect comprises a closed separation chamber connecting intake duct and exhaust duct, the said closed separation chamber comprises a filter mechanism inside, the outer surface of the said filter mechanism connects to the intake duct and the inner surface connects to the exhaust duct, and the said dust filtration system comprises a filter regeneration mechanism.

The said filter regeneration mechanism is a control component for the intake and exhaust of regenerated substances.

Between the said intake duct and the said exhaust duct, there are multiple closed separation chambers, and the said multiple separation chambers connect to the said intake duct through the intake branch and connect to the said exhaust duct through the exhaust branch.

The said intake branch has a valve inside.

The said intake branch and exhaust duct have a temperature monitoring component inside.

The said filter regeneration mechanism is a physical contact cleaning and brushing component.

The said filter regeneration mechanism comprised a physical contact cleaning and brushing component and a regenerated gas intake and exhaust control component.

The present invention includes a filter regeneration mechanism set in the closed separation chamber connecting intake duct and exhaust duct, which can recover the filtering capacity greatly decreased due to the adhesion of tar and ash to the filter surface and pores. The repeated regeneration directly reduces the cost of filter and greatly improves its service life. As the intake and exhaust control component slowly pushes regenerated substances through the closed separation chamber, the tar and ash at high temperature contact a small amount of oxygen, carbon dioxide or water vapor for a chemical reaction, in which the carbides react for a long time in the form of incomplete combustion and the product was pushed by the intake and exhaust control component away from the filter surface and pores to achieve the regeneration of its filtering capability. Between the said intake duct and the said exhaust duct, there are multiple closed separation chambers, which can work in parallel in the case of a large amount of mixed gas in the intake duct to improve the speed of solid-gas separation. After the regeneration process ends in the closed separation chamber with reduced filtering capacity, the dust removal system is started. The said intake branch has a valve inside that can easily switch the work state and regeneration state of any enclosed separation chamber so that the whole solid-gas separation system is always in a cyclic state of normal operation, ceaseless product and regeneration. The said intake branch and exhaust branch have a temperature monitoring component inside. The increasing temperature indicates high flow velocity and reaction speed of regenerated substances, whose content and flow velocity should be reduced; the decreasing temperature indicates low velocity of regenerated substances, whose content and flow velocity should be promoted. The temperature monitoring component is used for regeneration process control. The said filter regeneration mechanism is a physical contact and brushing component, that is, the filter surface-cleaning mechanism set in the filtration chamber can more quickly brush away the too thick filter cake on the filter surface, quickly recovering the filter capability. The said regeneration mechanism comprised a physical contact cleaning and brushing component and a regenerated gas intake and exhaust control component so that the surface thick filter cake can be cleaned, while the filter surface and pores can be cleaned by the chemical reaction. The joint action not only reduces the regeneration time but also greatly enhances the degree of regeneration so that the attachments to the filter surface and pores can be cleaned more thoroughly.

### BRIEF DESCRIPTION OF THE DRAWINGS

The present invention is further described in combination with the drawings:

FIG. 1 is a structure diagram of Embodiment A of the present invention;

FIG. 2 is a structure diagram of Embodiment B of the present invention;

FIG. 3 is a structure diagram of Embodiment C of the present invention;

FIG. 4 is a structure diagram of Embodiment D of the present invention.

### DETAILED DESCRIPTION OF THE INVENTION

### Embodiment 1

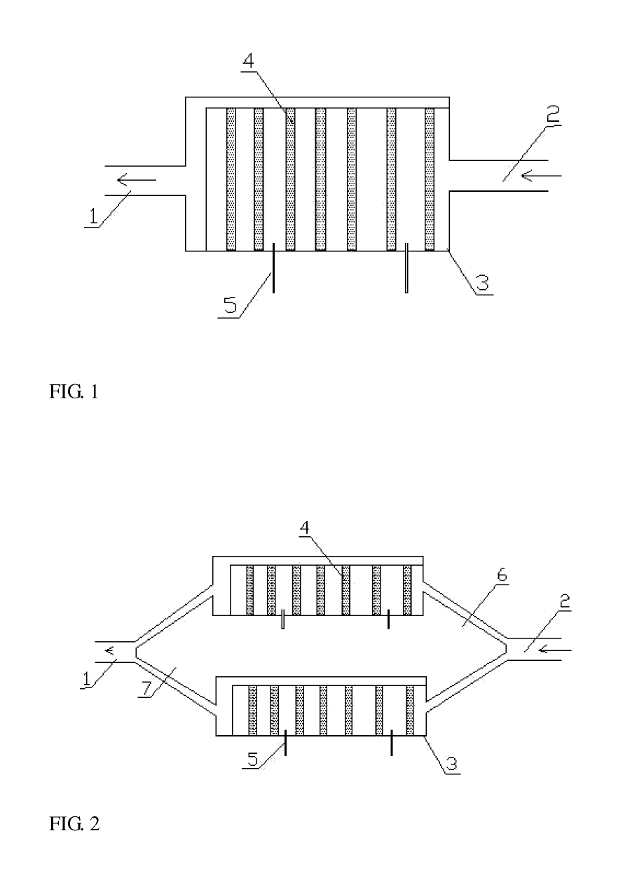

As shown in FIG. 1, a dust filtration system of gas mixture of high temperature oil gas, water vapor and precipitation-prone carbides, comprising a closed separation chamber 3 connecting intake duct 2 and exhaust duct 1, the said closed separation chamber 3 comprises a filter mechanism 4 inside, the outer surface of the said filter mechanism 4 connects to the intake duct 2 and the inner surface connects to the exhaust duct 1, and the said closed filter chamber 3 comprises a filter regeneration mechanism 5. The said filter regeneration mechanism is a control component for the intake and exhaust of regenerated substances. For example, the control component for the intake and exhaust of oxygen-containing gas or mixed gas of carbon dioxide and water vapor can control the effective gas content 3-11%. In the closed separation chamber 3 between the said intake duct 2 and the said exhaust duct 1, the filter regeneration mechanism 5 is set. After the filter works for a time, if the capacity of filter 4 reduces greatly due to the tar and coal ash filter adhering to the surface and pores and can not meet the normal working time, the regeneration mechanism works to recover the filter capacity to the proper level and the repeated regeneration directly reduces the filter cost and greatly improves its service life. As the intake and exhaust control component 5 slowly pushes regenerated substances, the tar and ash at high temperature contact a small amount of oxygen, carbon dioxide or water vapor for a chemical reaction, in which the carbides react for a long time in the form of incomplete combustion and the product was pushed by the intake and exhaust control component away from the filter surface and pores to achieve the regeneration of its filtering capability.

### Embodiment 2

As shown in FIG. 2, a dust filtration system of gas mixture of high temperature oil gas, water vapor and precipitation-prone carbides, comprising a closed separation chamber 3 connecting intake duct 2 and exhaust duct 1, the said closed separation chamber 3 comprises a filter mechanism 4 inside, the outer surface of the said filter mechanism 4 connects to the intake duct 2 and the inner surface connects to the exhaust duct 1, and the said closed filter chamber 3 comprises a filter regeneration mechanism 5. The said filter regeneration mechanism is a control component for the intake and exhaust of regenerated substances. For example, the control component for the intake and exhaust of oxygen-containing gas or mixed gas of carbon dioxide and water vapor can control the effective gas content 3-11%. Between the said intake duct 2 and the said exhaust duct 1, there are multiple closed separation chambers 3, and the said multiple separation chambers 3 connect to the said intake duct 2 through the intake branch 6 and connect to the said exhaust duct 1 through the exhaust branch 7. The said intake branch has a temperature monitoring component inside. The said multiple separation chambers connect to the said intake duct through the intake branch and connect to the said exhaust duct through the exhaust branch. The multiple closed separation chambers can work in parallel in the case of a large amount of mixed gas in the intake duct to improve the speed of solid-gas separation. More importantly, in the case of coexisting closed separation chambers, if one of them has decreased filter capacity, the overall system need not stop working. As the filter capacity decreased to a certain range, the separation chamber stops working, enters the regeneration program and then enters the separation system.

### Embodiment 3

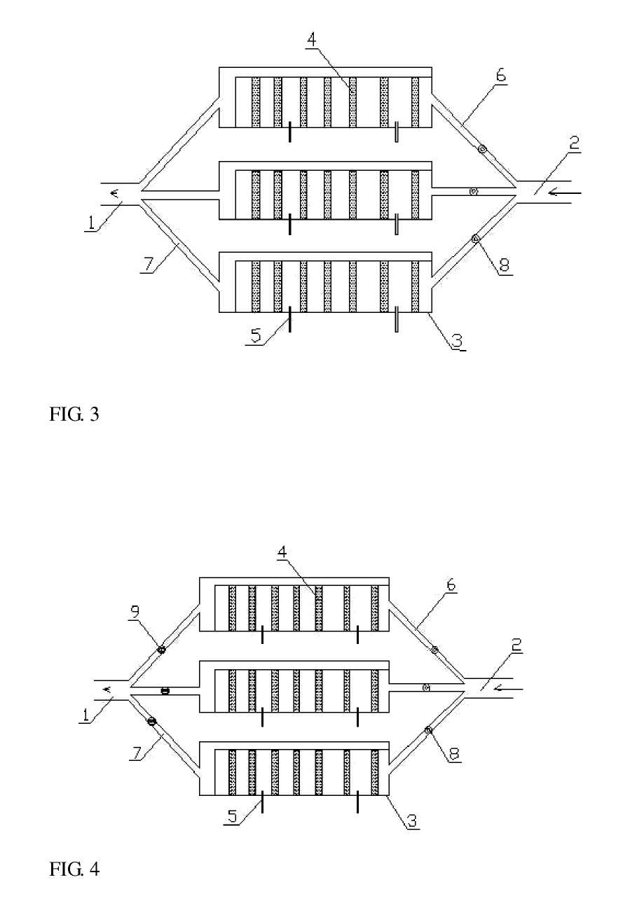

As shown in FIG. 3, a dust filtration system of gas mixture of high temperature oil gas, water vapor and precipitation-prone carbides, comprising a closed separation chamber 3 connecting intake duct 2 and exhaust duct 1, the said closed separation chamber 3 comprises a filter mechanism 4 inside, the outer surface of the said filter mechanism 4 connects to the intake duct 2 and the inner surface connects to the exhaust duct 1, and the said closed filter chamber 3 comprises a filter regeneration mechanism 5. The said filter regeneration mechanism is a control component for the intake and exhaust of regenerated substances. For example, the control component for the intake and exhaust of oxygen-containing gas or mixed gas of carbon dioxide and water vapor can control the effective gas content 5-11%. Between the said intake duct 2 and the said exhaust duct 1, there are multiple closed separation chambers 3, and the said multiple separation chambers 3 connect to the said intake duct 2 through the intake branch 6 and connect to the said exhaust duct 1 through the exhaust branch 7. The said intake branch 6 has a valve 8 inside, which can easily achieve the work state and regeneration state of any closed separation chamber 3 so that the whole solid-gas separation system is always in a cyclic state of normal operation, ceaseless product and regeneration.

### Embodiment 4

As shown in FIG. 4, a dust filtration system of gas mixture of high temperature oil gas, water vapor and precipitation-prone carbides, comprising a closed separation chamber 3 connecting intake duct 2 and exhaust duct 1, the said closed separation chamber 3 comprises a filter mechanism 4 inside, the outer surface of the said filter mechanism 4 connects to the intake duct 2 and the inner surface connects to the exhaust duct 1, and the said closed filter chamber 3 comprises a filter regeneration mechanism 5. The said filter regeneration mechanism is a control component for the intake and exhaust of regenerated substances. For example, the control component for the intake and exhaust of oxygen-containing gas or mixed gas of carbon dioxide and water vapor can control 3-5% of oxygen. Between the said intake duct 2 and the said exhaust duct 1, there are multiple closed separation chambers 3, and the said multiple separation chambers 3 connect to the said intake duct 2 through the intake branch 6 and connect to the said exhaust duct 1 through the exhaust branch 7. The said intake branch 6 has a valve 8 inside. The said exhaust branch 7 has a valve 9 inside.

### Embodiment 5

As shown in FIG. 3, a dust filtration system of gas mixture of high temperature oil gas, water vapor and precipitation-prone carbides, comprising a closed separation chamber 3 connecting intake duct 2 and exhaust duct 1, the said closed separation chamber 3 comprises a filter mechanism 4 inside, the outer surface of the said filter mechanism 4 connects to the intake duct 2 and the inner surface connects to the exhaust duct 1, and the said closed filter chamber 3 comprises a filter regeneration mechanism 5. The said filter regeneration mechanism is a physical contact cleaning and brushing component, such as the automatic dedusting brush made of heat-resisting bristles.

### Embodiment 6

As shown in FIG. 3, a dust filtration system of gas mixture of high temperature oil gas, water vapor and precipitation-prone carbides, comprising a closed separation chamber 3 connecting intake duct 2 and exhaust duct 1, the said closed separation chamber 3 comprises a filter mechanism 4 inside, the outer surface of the said filter mechanism 4 connects to the intake duct 2 and the inner surface connects to the exhaust duct 1, and the said closed filter chamber 3 comprises a filter regeneration mechanism 5. The said filter regeneration mechanism is a physical contact cleaning and brushing component, such as the combination of the automatic dedusting brush made of heat-resisting bristles with the regenerated gas intake and exhaust control component. After the dedusting lasts for a time and stops working, the generated gas intake and exhaust control component is started. For example, the control component for the intake and exhaust of oxygen-containing gas or mixed gas of carbon dioxide and water vapor can control 5-11% of effective gas. The chemical reaction can clean the filter surface and the joint action reduces the regeneration time but also greatly enhances their regeneration degree so that the cleaning of attachments to the filter surface and pores can be cleaned more thoroughly.

1. A dust filtration system of gas mixture of high temperature oil gas, water vapor and precipitation-prone carbides comprising:
a closed separation chamber connecting intake duct and exhaust duct, wherein the closed separation chamber comprises a filter mechanism inside, the outer surface of the filter mechanism connects to the intake duct and the inner surface connects to the exhaust duct, and wherein the dust filtration system comprises a filter regeneration mechanism.

2. The dust filtration system according to claim 1, wherein the filter regeneration mechanism is a control component for the intake and exhaust of regenerated substances.

3. The dust filtration system according to claim 1, wherein between the intake duct and the exhaust duct there are multiple closed separation chambers, and the multiple separation chambers connect to the intake duct through the intake branch and connect to the exhaust duct through the exhaust branch.

4. The dust filtration system according to claim 3, wherein the intake branch has a valve inside.

5. The dust filtration system according to claim 4, wherein the intake branch and exhaust duct have a temperature monitoring component inside.

6. The dust filtration system according to claim 5, wherein the filter regeneration mechanism is a physical contact cleaning and brushing component.

7. The dust filtration system according to claim 1, wherein the filter regeneration mechanism is a physical contact cleaning and brushing component.

8. The dust filtration system according to claim 1, wherein the filter regeneration mechanism comprised a physical contact cleaning and brushing component and a regenerated gas intake and exhaust control component.

9. The dust filtration system according to claim 2, wherein between the intake duct and the exhaust duct there are multiple closed separation chambers, and the multiple separation chambers connect to the intake duct through the intake branch and connect to the exhaust duct through the exhaust branch.

10. The dust filtration system according to claim 9, wherein the intake branch has a valve inside.

11. The dust filtration system according to claim 10, wherein the intake branch and exhaust duct have a temperature monitoring component inside.

12. The dust filtration system according to claim 11, wherein the filter regeneration mechanism is a physical contact cleaning and brushing component.
